(19) United States
(12) Patent Application Publication
(10) Pub. No.: US 2013/0030772 A1
(43) Pub. Date: Jan. 31, 2013

(54) Optimisation of a wind turbine

(71) Applicants: Hans Laurberg, Arhus C (DK); Anders Nygaard Rasmussen, Kobenhavn (DK)

(72) Inventors: Hans Laurberg, Arhus C (DK); Anders Nygaard Rasmussen, Kobenhavn (DK)

(21) Appl. No.: 13/558,417

(22) Filed: Jul. 26, 2012

(30) Foreign Application Priority Data
Jul. 27, 2011 (EP) EP11175585

(51) Int. Cl. G06F 17/50; E02D 27/42

(52) U.S. Cl. 703/1; 52/292

(57) ABSTRACT

A method of optimising a construction of a basis of a wind turbine is provided. A local load environment situation of a construction location is analysed, which results in local load-relevant environment data, based on which construction instructions are generated. These are further based on a set of predefined rules for processing the local load-relevant environment data, such that in a first selected region of the basis along a circumference of the tower and/or in a first selected region of the foundation the carrying structure of the basis is weakened in at least one selected horizontal cross-section with respect to possible maximum loads in comparison with a second region of the basis in the selected cross-section.

### CROSS REFERENCE TO RELATED APPLICATIONS

This application claims priority of European Patent Office application No. 11175585.6 EP filed Jul. 27, 2011. All of the applications are incorporated by reference herein in their entirety.

### FIELD OF INVENTION

The illustrated embodiments relate to a method of optimising a construction of a basis of a wind turbine comprising at least a tower and a foundation on which the tower rests, both the tower and the foundation comprising a carrying structure each. It also concerns a system for such purpose and such basis of a wind turbine.

### BACKGROUND OF INVENTION

Today's wind turbines comprise towers which are based on a construction outline that implies that at any horizontal cross section there can be found an essentially round shape, i.e. a circular shape. “Essentially round” means that the tower can be completely circular as would be the case for instance with cast concrete towers. It may, however, also be made up of plain elements which are aligned along the perimeter and orientated along a circle. In other words, in both cases a circle is the shape-giving geometric figure on which the horizontal cross-sectional shape is based. Such outline implies that the tower can withstand the same loads from any direction, i.e. from above or from any side of the wind turbine to the same extent.

Such construction implies that equally strong elements and/or an equally strong design all around the perimeter of the tower is realised. This strength is defined by a calculated or otherwise predicted maximum load. The higher this load, the greater the strength of the carrying structure. That also implies that the costs in effort, time, material and money for the construction are accordingly higher.

As for the foundation of the tower, which is a part of the basis, this may be an artificial foundation such as a concrete foundation or it might be a natural foundation such as a rock. Combinations thereof may also be realised; according to the state-of-the-art such foundations have been designed to be equally strong at any horizontal cross section because otherwise the distribution of loads in the tower would meet an unequal distribution of loads in the foundation. Therefore, the aim has always been to match the load distribution which the tower can resist and the load distribution which the foundation can resist. In essence, it can be concluded that it has always been the case that foundations provide for a structure which resists equal loads all over its horizontal cross section. Again, depending on the possible maximum loads, the construction of such foundation can be very costly with respect to effort, time, material and money.

### SUMMARY OF INVENTION

It is the object of the illustrated embodiments to provide for an optimised construction of the basis of a wind turbine of the above-mentioned kind.

This object is met by the features of the independent claims

Thus, in accordance an embodiment, the method of the above-mentioned kind comprises at least the following steps:
analysing a local load environment situation of a construction location where the wind turbine is to be built and deriving from that analysis local load-relevant environment data,
creating construction instructions for structuring the basis, whereby the construction instructions are based on the local load-relevant environment data and on a set of predefined rules for processing the local load-relevant environment data such that in a first selected region of the basis along a circumference of the tower and/or in a first selected region of the foundation the carrying structure of the basis is weakened, i.e. intentionally made weaker, in at least one selected horizontal cross-section with respect to possible maximum loads in comparison with a second region of the basis in the selected cross-section,
outputting the construction instructions for further processing.

The illustrated technique makes use of an analysis of the local environment situation and can for instance include parameter values concerning wind influences and others (see below). From this analysis there results so-called local load-relevant environment data. These environment data represent the local load environment situation, and may do so in a very detailed way. In particular, they may represent those features of the local load environment which have the largest influence on the predicted load distribution of the basis of the wind turbine. Thus in one embodiment, the load environment data includes parameter values the influence of which amounts to at least 50% of the overall influences on the load distribution of the basis of the wind turbine, in particular, for example, 70%.

Taking into consideration these local load environment data construction instructions are derived, i.e. created. Such construction instructions may be considered to be construction guidelines comprising as a set of parameters and/or orders serving to give all relevant information on the basis of which the wind turbine's basis can be built. Such construction instructions can be based on a predefined set of instructions of a standard type which can be used as a kind of template some or all parameter values of which can be altered in order to arrive at a construction outline as desired within the context of the embodiments illustrated. Further, use can be made of user inputs, for instance of certain preferences by an architect or a civil engineer. In addition, use is made of a set of predefined rules, which can for instance be stored in a memory, i.e. be derived from a database.

Based on these rules the basis of the wind turbine is designed dependent on the input listed above. Therefore, in essence, the predefined rules contain criteria which made possible a particular design of the basis: this design is such that in a first selected region of the basis along a circumference of the tower and/or in a first selected region of the foundation the carrying structure of the basis is designed weaker in at least one selected horizontal cross-section. Such weakening may be planned for several selected horizontal cross-sections, particularly, more than 50% and even more particularly, all horizontal cross-sections. In particular, that ruling may apply to at least 50% or, for example, all of the horizontal cross-sections in the lower half of the tower.

In other words, some regions of the basis are decidedly weakened than others or—vice versa—some regions are made stronger than others. Throughout this description reference is always made to a weakening rather than strengthening of regions as the effect wished for in the context of the illustrated embodiments is that material and effort be saved rather than increased. Therefore, in comparison with the state-of-the-art wind turbine bases some regions are weaker rather than stronger than before. The result is construction instructions which are realised such that a non-uniform basis—the foundation and/or the tower—will be built if the construction instructions are realised. To conclude, the general idea of the illustrated embodiments is based on adapting the strength of the tower, i.e. its ability to resist loads, depending on a direction of loads—the basis can thus handle more loads from selected directions than from other selected directions.

Concerning the maximum loads which are taken into account, these loads may come from directly above and/or from any of the sides of the basis. In essence, these loads will all finally be directed into the foundation and normally be transferred by the tower or parts thereof. They may be induced by winds, waves (in offshore conditions) or other factors. For instance, if a wind turbine is built in a region with hills the surface of the ground may rise to one side while fall to the other side (i.e. be inclined). Therefore, it can be expected that forces or loads directed into the basis at one side at which the surface falls may be considerably higher than such forces or loads directed into it at the opposite side, whereby it needs to be stressed that this is a generalsation which does not generally apply. For instance, such load distribution may be different due to wind conditions.

When the construction instructions are generated they are output for further processing, for instance by printing out plans and/or by feeding a construction programme with the parameter values and/or orders comprised by the construction instructions.

It must be noted that in the context of the illustrated embodiments throughout the description, one in fact rather negligible factor is completely taken out of account: the “carrying structure” of the basis is defined such that doors, windows or any other openings not decidedly serving to weaken the carrying structure, will not be taken into account. Rather, the carrying structure is modelled as if it contained no such openings at all. In general, one can state that the carrying structure in these regions of openings of the tower is normally strengthened by frames or the like so that anyway one cannot speak of a weakening in their context but rather of a strengthening of the carrying structure.

One effect of the method according to the illustrated embodiments is that material, effort and, lastly, costs can be saved by for instance reducing material and/or weakening parts and/or material in other ways in some region of the basis of the wind turbine. In a way one can speak of a tailor-made basis which takes into account the distribution of expected loads depending on their direction of influence on the basis while at the same time also still considering possible peak (or maximum) loads from other directions. It can thus be expected that the basis of a wind turbine produced based on the construction instructions generated by a method according to the illustrated embodiments can be expected to produce about 20 to 30% less effort (material, construction time and expenses) in comparison with a state-of-the art basis.

According to one embodiment, a system of the above-mentioned kind for optimising a construction of a basis of a wind turbine comprising at least a tower and a foundation on which the tower rests, both the tower and the foundation comprising a carrying structure each, comprises at least:
an input interface for data representing a local load environment situation of a construction location where the wind turbine is to be built,
an analysation unit realised to analyse the local load environment situation and to derive from that analysis local load-relevant environment data,
a rule database supplying in operation a set of predefined rules for processing the local load-relevant environment data,
an instruction unit which in operation creates construction instructions for structuring the basis, the construction instructions being based on the local load-relevant environment data and on the set of predefined rules, such that in a first selected region of the basis along a circumference of the tower and/or in a first selected region of the foundation the carrying structure of the basis is weakened in at least one selected horizontal cross-section with respect to possible maximum loads in comparison with a second region of the basis in the selected cross-section,
an output unit for outputting the construction instructions for further processing.

The system may be one integral unit comprising all the elements describe above, but the term “system” also implies that any of these elements can be assembled in different locations, for instance be realised as computer-based units operated on different processors interconnected by a computer network such as a local area network and or the internet. The system thus may comprise a housing in which one, several or indeed any of the elements described above are included or may just be comprised of several programmes run on one or several processors of computer systems. It can thus be concluded that the system and indeed any of its units can be based on hardware and/or on software, but also on a combination thereof.

At least for this reason the illustrated embodiments also relate to a computer programme product directly loadable into the memory of a programmable device comprising software code portions for performing the steps of the above-described method.

The result of the method can eventually be the construction of a basis of a wind turbine. Therefore, one embodiment relates to such basis of a wind turbine of the above-mentioned kind comprising at least a tower and a foundation on which the tower rests, both the tower and the foundation comprising a carrying structure each. In a first selected region of the basis along a circumference of the tower and/or in a first selected region of the foundation the carrying structure of the basis is weaker in at least one selected horizontal cross-section with respect to possible maximum loads in comparison with a second region of the basis in the selected cross-section. In effect, one of the embodiments also concerns a wind turbine comprising a basis as described above.

Specific embodiments are set forth in the dependent claims, as revealed in the following description. Features revealed in the context of the method may also be realised in the context of any of the claimed products and vice versa.

Principally the illustrated method can stand alone on its own, for instance as performed by planners such as architects and/or civil engineers. For instance, using the method may lead to an outline of a wind turbine's basis based on which outline a planner may decide that he does not want to realise the construction project despite the savings realisable due to the present technique. This may for example be the case if the method according to the invention is applied in such circumstances in which the construction of a state-of-the-art wind turbine would be too costly and/or involve too much effort anyway. Therefore, the illustrated method according may be applied in order to find out whether or not by using this method a construction can be realised which is still feasible under the given circumstances. This may lead to a positive result because of the saving effects of the illustrated method, but it may also lead to another negative result so that the wind turbine is not going to be built. In this sense, the illustrated method provides a chance—combined with a calculation basis—for possibly constructing wind turbines in locations in which it otherwise would not be feasible.

A wind turbine may be built, i.e. constructed, according to the construction instructions, i.e. the basis of the wind turbine is built based on the construction instructions. This means that the construction instructions are not mere planning parameters and/or orders but that they are realised by applying them in practise.

In order to make sure that the load resistance of the basis is well-balanced and distributed all along the perimeter of the basis, it may be even more advantageous to have more than just two regions with different resistance values for loads. The construction instructions may be such that in a first selected region of the basis along a circumference of the tower and/or in a first selected region of the foundation the carrying structure of the basis is weakened in at least one selected horizontal cross-section with respect to possible maximum loads in comparison with a second region of the basis in the selected cross-section and that in the same horizontal cross-section there is a third selected region with yet another different strength with respect to possible maximum loads than the first and the second region.

Generally, it is necessary that the wind turbine basis resists any kind of expected (maximum) loads. This in particular includes extreme loads and fatigue loads. Extreme loads may occur for instance of the wind turbines operation completely fails, for example on a nacelle level of the wind turbine. Such failure may lead to forces and loads in virtually any direction and can be considered to be a kind of worst case. Fatigue loading in contrast is caused by forces (and loads) which constantly or often inflict loads onto the wind turbine's basis, such as forces by wind and by waves. Futhermore, the turbines own dynamics are also a cause for wear and fatigue. This can be reduced to a minimum by making sure that these dynamics have a different frequency to the eigenfrequency of the tower. This way resonance effects can be avoided.

According one embodiment, the basis is locally weakened with respect to possible maximum fatigue loads. As extreme loads can generally be expected from any direction, it may be the case that as a general rule a weakening with respect to extreme loads is not wished for. Such extreme loads may be caused by storms or heavy waves, earthquakes or the like. However, the fatigue load distribution over the wind turbine can usually be calculated beforehand and therefore a wind turbine be designed according to that particular distribution.

This has the effect that it need not be expected that even under severe and extreme conditions the carrying structure of the basis is weaker than any other carrying structure of a basis of a wind turbine according to the state-of-the-art. In other words: one makes only use of the factor fatigue which can be predicted even over longer periods of time such as the typical lifetime span of a wind turbine basis.

Generally, the basis can only be weakened in one first region and left as strong as usual in any other regions. However, it may be so that in any horizontal cross-section the basis is symmetrically built, e.g. axially symmetric and/or symmetric with respect to a point, in particular the wind turbine tower. For example, the tower and/or the foundation may be designed as a radial symmetric arrangement, i.e. an arrangement in which several cutting planes perpendicular to a horizontal cross-section produce roughly identical pieces. This can enhance the overall stability of the basis, in particular of the tower.

One such embodiment with a (radial) symmetrical arrangement is realised by a method in which the predefined rules are such that the basis is weakened in at least two first regions which are positioned opposite of one another along the circumference of the tower in the selected horizontal cross-section. Such arrangement is particularly useful in such cases in which wind and/or waves from one particular direction are the main cause for loads, in particular fatigue loads. For instance in many parts of Western Europe there is typically a westerly wind. Therefore, the fatigue of the basis caused by the wind is mainly in those parts of the basis of a wind turbine which face either westwards or eastwards. Thus, weakening the wind turbine in the northerly and southerly direction at the same time does not constitute any particular additional weakening of the overall basis of the wind turbine with respect to fatigue loads.

As already mentioned before, the load-relevant environment data can represent various factors. According to one embodiment the local load-relevant environment data considered are selected from at least one of the following:
wind data about prevailing winds, i.e. wind directions and/or their strength, in the construction location,
surface data about a ground surface in the construction location,
wave behaviour data about expected directions and/or strengths of waves in an offshore application in the construction location.

The predefined rules are such that the first region is chosen in dependence of the local load-relevant environment data.

As for the wind data, these can be for instance derived from a database in which statistical data about wind directions, possibly combined with values of wind strengths, are supplied. Such data can be generated for virtually every spot of the Earth without any particular difficulty. Another possibility, which can be used additionally or alternatively, is that the wind data are derived from data acquired by other wind turbines in close proximity to the wind turbine in question. If a wind park already exists and there is only yet another wind turbine or several additional wind turbines to be installed in this wind park or close by, the wind directions have been measured by the existing wind turbines of the wind park or by wind metres which operate in the context of this wind park, the data from which can also be used.

As mentioned before, the basis comprises the foundation and the tower. Whereas it is possible to locally weaken the foundation in one first selected region, it is particularly desirable that the predefined rules are such that the tower is locally weakened in a first region. While it may be difficult and more costly to actually locally weaken the foundation, such weakening is particularly simple to plan and to realise physically when it comes to the tower. Such way the foundation may be designed according to an overall standard of load distribution on foundations whereas it is only the tower which is locally weakened in the first region.

If the tower is weakened, there are several possible methods of realisation of such weakening. Their choice depends on several factors, amongst others on the kind of material used for the tower. Such tower can for instance be realised as a (tubular) steel tower, as a shell tower, as a lattice tower, or as a concrete tower—or indeed as a combination of any one of those.

According to a first method of realisation the predefined rules are such that the tower comprises a set of a group, i.e. of one or several, of construction elements. At least a first group of construction elements is weaker than a second group of construction elements of the set. Such construction elements can for instance be shells and/or lattices and/or plates. A set of them comprises such construction elements which are positioned adjacent to one another. For instance, such construction elements can be essentially aligned along the circumference of a circle which defines the circumference of the tower in a particular horizontal cross-section.

The first group of construction elements may have a different size and/or shape and/or amount of construction elements than the second group of construction elements. For instance, there can be smaller construction elements in the first group or alternatively larger construction elements with respect to at least one extension of the construction elements. The shape of the construction elements belonging to the first group may constitute one plane while those construction elements belonging to the second group may be non-linear in one direction or alternatively the other way round. Depending on the size of the construction elements of the first group the amount in a certain area with a predefined extension, i.e. dimension, may also vary.

The second realisation method for weakening the tower locally, which can be used additionally or alternatively to the first method of realisation, is that the predefined rules are such that the tower is locally weakened by locally decreasing its thickness and/or a thickness of a construction element of it. In particular, the thickness of the construction elements and/or of the tower refers to a covering structure which establishes an outer surface of the tower. Such local weakening by simply making regions thinner than others is particularly easy to plan and to produce. It also has am advantage that even once the wind turbine has been realised and is completely constructed such weakening by varying the material strength or thickness can easily be detected even by non-experts. This way it will be clear at any time—even in the aftermath of the establishment of the wind turbine—that this particular wind turbine has been constructed according to the present technique. Such fact may be considered when it comes to particular maintenance works or add-ons to the tower, for instance when holes are drilled somewhere into the surface of the tower.

The third method of realisation, which again can be used in addition or alternatively with respect to the one mentioned before, is that the predefined rules are such that the tower is locally weakened by locally changing its material quality (i.e. especially the material quality of its covering or parts thereof) and/or a material quality of a constructional element of it. The term “material quality” in particular refers to the strength of the material, i.e. the loads which it can resist. For instance, different materials can be chosen for locally weakening the tower and the same principal material but with a quality at a lower level. The tower is thus “tailor-made” in the sense that only the necessary material is used in a particular region, this necessity being defined by the (expected, i.e. calculated or predicted) overall load distribution. This third method offers an advantage of being an easy realisable measure by which nevertheless enormous savings can be realised.

The fourth method of realisation, again applicable alternatively or additionally to any of the previously mentioned ones, is that the predefined rules are such that the tower is locally weakened by locally changing its directional stiffness. This can for instance be realised by using different supports within the tower, in particular such supports which follow an essentially vertical overall extension of the tower. For example, more or less metal wires or columns can be established along the perimeter of the general outline of the wind turbines tower which can constitute the support for outer shell elements of the tower. Such wires can also be used when the tower is made of steel-reinforced concrete so that less steel wires are introduced into the concrete in the first region as defined above in comparison with the second region.

According to a fifth method of realisation, again to be used additionally or alternatively with any of the others, the predefined rules are such that diameters along a circumference of the tower in at least one of its horizontal cross sections differ. This implies that instead of a purely circular outline of the tower in the horizontal cross sections, the tower either has a shape which includes corners, or it may have an essentially non-circular shape such as an oval shape. A change of shape, i.e. form, i.e. geometry can also be applied in the context of the foundation.

It may however be noted, that cross-sectional shapes which in essence constitute a circular shape are explicitly excluded from this method as they would fall under the definition of a “circular shape”. Such nearly circular shapes can be realised by arranging, i.e. fixing construction elements around a circular shape in such way that they are aligned adjacent to one another. In such case the outside shape of the tower need not necessarily be exactly circular, but it is still based on a circle in the sense that it is arranged around a circular structure.

In particular with respect to what has been said just before, the predefined rules are such that the centre of gravity of the tower is kept at the geometric centre of the tower. The centre of gravity can be derived by virtually going through all horizontal cross-sections and deriving their centre of gravity, then deriving from the centres of gravity a middle value. If this middle value falls together with the geometric centre of the tower, that secures that the tower in itself is particularly stable despite the weakening as wished for in the context of the illustrated embodiments.

If the foundation is to be weakened (additionally to the tower or only on its own), this may be accomplished by leaving out reinforcement elements which would be necessary to achieve an equal load distribution overall in the foundation. Such reinforcement elements can also be used in such cases in which the foundation is not a purely artificial one, i.e. a combination of a natural and an artificial foundation, thus comprising both natural and artificial elements. In particular, such reinforcement elements within the artificial parts can be added or left out. Thus in those regions of the foundation which are to be weakened, leaving out some more all reinforcement elements would be an easy way of how to effectively and cost-savingly weaken the foundation in the first region. Such elements may for instance be metal elements comprised in a concrete foundation, the amount and/or the quality of which can be varied so that the amount and/or the quality are reduced in the first region while not (or not to such an extent) in the second region.

Other objects and features of the illustrated embodiments will become apparent from the following detailed descriptions considered in conjunction with the accompanying drawings. It is to be understood, however, that the drawings are designed solely for the purposes of illustration, and are not meant to be limiting.

### BRIEF DESCRIPTION OF THE DRAWINGS

In the drawings, like reference numbers refer to like objects throughout. Objects in the diagrams are not necessarily drawn to scale.

FIG. 1 shows a schematic block diagram of a method according to one embodiment,

FIG. 2 shows a top view of a tower according to the state-of-the-art,

FIG. 3 shows a side view of the same tower as depicted in FIG. 2,

FIG. 4 shows a diagram of wind distributions in a particular construction location,

FIG. 5 shows a schematic view of a horizontal cross-section of a basis of a wind turbine according to a first embodiment,

FIG. 6 shows a schematic view of a horizontal cross-section of a basis of a wind turbine according to a second embodiment,

FIG. 7 shows a schematic block diagram of a system according to one embodiment.

### DETAILED DESCRIPTION OF INVENTION

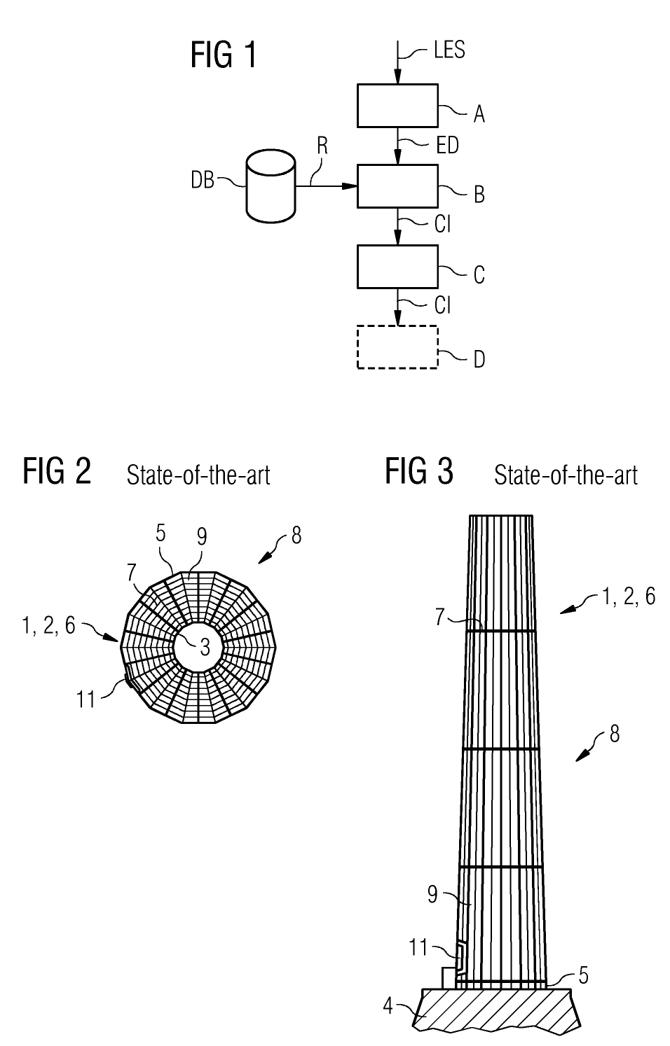

FIG. 1 shows in a schematic block diagram the steps of a method according to one embodiment. In a first step A a local environment situation LES of a construction location, where a wind turbine is planned to be built is analysed. From that analysis there result local load-relevant environmental data ED representing the local environment situation LES. In particular, these local load-relevant environment data ED may comprise parameter values which represent wind conditions and/or other weather conditions. Furthermore, they may, if the wind turbine to be built in an offshore location, represent the influence of waves, in particular wave directions and typical maximum heights of waves in the construction location. In contrast, if the wind turbines is to be built in an onshore location, they may also represent surface conditions of the site on which the wind turbine is to be built. For instance, information whether the surface is evenly horizontal or essentially angular to the horizontal direction (i.e. inclined), may be included.

These local load-relevant environmental data ED are then (in a second step B) used for creating construction instructions CI. Use is made of a set of predefined rules R from a database DB, which rules R give indications of how to derive from the local load-relevant environment data ED the construction instructions CI. These construction instructions CI are such that a realisation of a basis of a wind turbine based on them results in the following: in a first selected region of the basis of a wind turbine along a circumference of the wind turbine's tower and/or in a first selected region of the tower's foundation the carrying structure of the basis is weakened in at least one selected horizontal cross-section with respect to possible maximum loads in comparison with a second region of the basis in the selected cross-section.

In a third step C the construction instructions CI are output to a user and/or to further processing means such as a computer processor or the like.

In an optional step D the wind turbine, in particular the basis of the wind turbine, is built based on the construction instructions CI.

FIGS. 2 and 3 show a tower 6 of a wind turbine 8 according to the state-of-the-art. The tower 6 comprises a carrying structure 2. Together with a foundation 4 (cf. FIG. 3) the tower 6 is part of up a basis 1 of the wind turbine 8. At its lower end facing towards the foundation 4 the tower 6 has a lower circumference 5 whereas on its top end facing towards a nacelle (not shown) it has a top circumference 3 the diameter of which is smaller than that of the lower circumference 5. Both the upper and lower circumferences 3, 5 have an essentially circular shape which is defined by the form of a number of shells 9 which each have a plane form and which are aligned adjacent to one another around a circular line which defines the circumferences in any horizontal cross-section of the tower 6. The tower 6 has several levels interconnected by interfaces 7 at which the shells 9 of different levels are aligned in the vertical direction. The tower 6 also comprises an opening 11 realised as a door 11. When referring to the carrying structure 2 of the tower 6 the door 11 and indeed any other similar openings (not shown) are neglected.

The tower 6 and the foundation 4, i.e. the complete basis 1 of the wind turbine 8 are completely constructed such that all around the tower 6 and in any cross-section of the foundation 4 equal loads can be resisted, i.e. compensated. This is due to construction parameters which take into account that loads from virtually any direction, in particular from side directions, have to be resisted so that in fact the maximum predicted load coming from any side of the wind turbine 8 is the basis of the calculation of the strengths of the basis overall. It may be noted that the maximum possible loads of the tower 6 and of the foundation 4 may still vary.

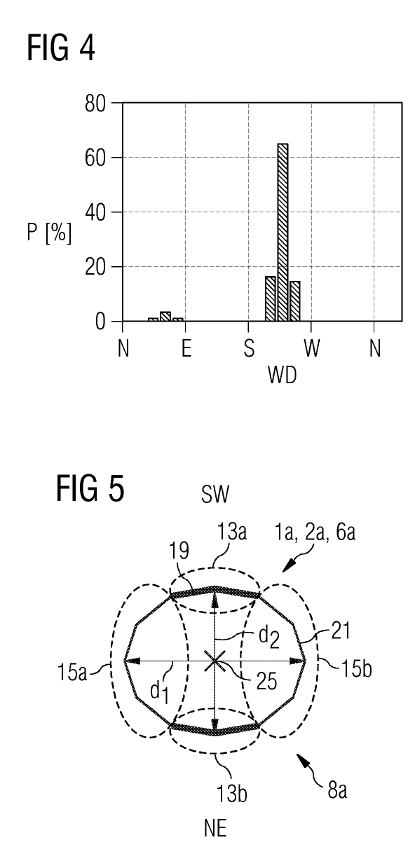

FIG. 4 shows a schematic diagram of wind conditions at a selected construction location where a wind turbine 8 is situated. The probability P in % is depicted over the wind data WD of time of winds blowing from wind directions which winds have a power which provides for power outputs of the wind turbine 8 above a threshold value of 25% of its nominal power output. It can be seen that essentially the wind in this construction location comes from the south-westerly direction and very few times from the north-easterly direction. Therefore, it can be concluded that the main loads and in particular the main fatigue loads which the basis 1 of the wind turbine 8 has to compensate in such a construction location will come from those two mentioned principal directions. In contrast, virtually no winds are expected from the south-easterly and north-westerly directions.

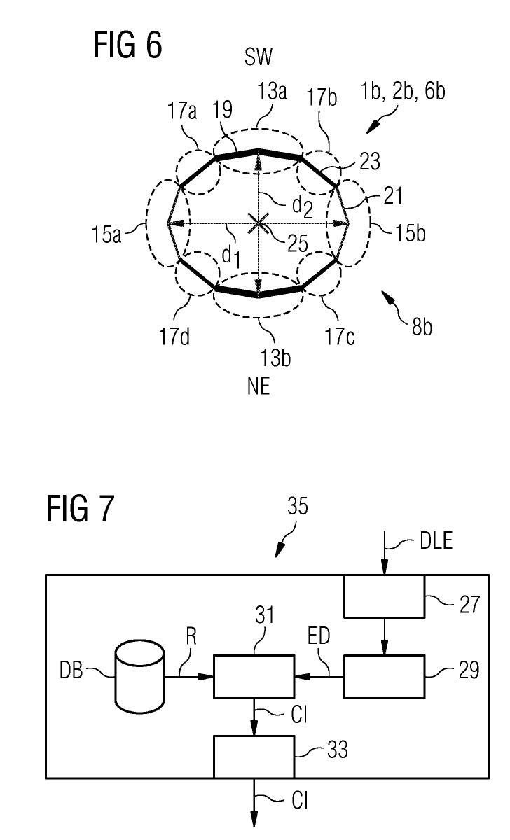

These wind data WD are now used as a basis of the optimisation of the construction of the basis of a wind turbine as shown, for example, in FIGS. 5 and 6, for instance for the construction of a second wind turbine to be built in close proximity of the wind turbine 8. A close proximity which falls under the definition of the same construction location is within a range of 10 kms, or more specifically 5 kms, or even more specifically 1 km of the previously established wind turbine 8.

FIGS. 5 and 6 show two different embodiments of a basis.

In FIG. 5 a basis 1a of a wind turbine 8a is shown. It comprises a carrying structure 2a of a tower 6a in a horizontal cross-section anywhere along the vertical extension of the tower 6a. Along its circumference the tower 6a is made up of shells 19, 21. In two first regions 15a, 15b there are arranged shells 21 of a smaller strength, i.e. thickness, than in two second regions 13a, 13b, where the shells 19 are in contrast thicker than the firstly-mentioned shells 21. The two second regions 13a, 13b face in the south-westerly and in the north-easterly direction. As a result, the tower 6a and with it the basis 1a are weakened in the two first regions 15a, 15b in comparison with the second regions 13a, 13b in this particular horizontal cross-section. All along the vertical extension of the tower 6a such a principle outline of stronger and wekaer regions may be realised.

Furthermore, the tower 6a has a non-circular shape. This can be seen by looking at the two diameters d₁, d₂ depicted in FIG. 5. In the same horizontal cross-section a first diameter d₁ connecting the two first regions 15a, 15b is larger than a second diameter d₂ connecting the two second regions 15a, 15b. This makes up for an essentially oval shape of the horizontal cross-section of the tower 6a. This way the tower 6a is also regionally weakened, respectively strengthened in other regions. In this particular case, the tower 6a is strengthened with respect to loads coming from the south-easterly and the north-westerly side. Therefore, the tower 6a has been weakened in these two directions by weakening the thickness of the respective shells 21 whereas at the same time it is strengthened by the increased first diameter d₁. This strengthening does not completely compensate the weakening due to the reduced thickness of the shells 21, but rather balances it to a certain limited extent.

FIG. 6 shows the same features as discussed with reference to FIG. 5, so that the reference numbers 1b, 2b, 6b and 8b refer to a basis 1a, a carrying structure 2a, a tower 6b and a wind turbine 8b. The feature differ in one respect, namely that the first regions 15a, 15b are reduced in their extent and that between the first regions 15a, 15b and the second regions 13a, 13b there are positioned third regions 17a, 17b, 17c, 17d in which the thickness of shells 23 is in between the thickness of the shells 21 positioned in the first regions 15a, 15b and the shells 19 positioned in the second regions 13a, 13b. Therefore, a kind of transfer area is realised by the shells 23 in the third regions 17a, 17b, 17c, 17d so that the load resistance is not abruptly reduced as was the case in the embodiment shown in FIG. 5.

FIG. 7 shows a schematic block view of a system 35 according to one embodiment. It comprises an input interface 27 via which data DLE which represent a local environment situation LES can be received.

These data DLE are transferred into an analysation unit 29 which analyses the local load environment situation LES and therefrom derives local load-relevant environment data ED. These local load-relevant environment data ED are then used in order to generate construction orders CI. This is carried out based on rules R from a rule database DB in the sense as described in the context of FIG. 1. These construction orders CI are then output via an output unit 33 realised as an output interface 33. They can then for instance be sent to a printing device and/or to a display device so that construction staff can evaluate the construction instructions CI and possibly construct a basis of a wind turbine based on the construction orders CI.

Although the present invention has been disclosed in the form of illustrated embodiments and variations thereon, it will be understood that numerous additional modifications and variations could be made thereto without departing from the scope of the invention. In particular, the tower may have a cast shape, for instance made of concrete, rather than be made up of construction elements such as shells. Also, the foundation of the basis can be adapted in a similar manner as described with reference to the tower. A particular focus can be directed towards reinforcement elements in the foundation which may be added or reduced in order to weaken the foundation locally. Accordingly, the particular arrangements disclosed are meant to be illustrative only and should not be construed as limiting the scope of the claims or disclosure, which are to be given the full breadth of the appended claims, and any and all equivalents thereof.

For the sake of clarity, it is to be understood that the use of “a” or “an” throughout this application does not exclude a plurality, and “comprising” does not exclude other steps or elements.

1. A method of optimising a construction of a basis of a wind turbine, the basis comprising at least a tower and a foundation on which the tower rests, both the tower and the foundation comprising a carrying structure each, the method comprising:
analysing a local load environment situation of a construction location where the wind turbine is to be built and deriving from that analysis local load-relevant environment data,
creating construction instructions for structuring the basis, wherein the construction instructions are based on the local load-relevant environment data and on a set of predefined rules for processing the local load-relevant environment data, such that in a first selected region of the basis along a circumference of the tower and/or in a first selected region of the foundation the carrying structure of the basis is weakened in at least one selected horizontal cross-section with respect to possible maximum loads in comparison with a second region of the basis in the selected cross-section, and
outputting the construction instructions for further processing.

2. The method according to claim 1, wherein the wind turbine is built according to the construction instructions.

3. The method according to claim 1, wherein the basis is locally weakened with respect to possible maximum fatigue loads.

4. The method according to claim 1, wherein the predefined rules are such that the basis is weakened in at least two first regions which are positioned opposite of one another along the circumference of the tower in the selected horizontal cross-section.

5. The method according to claim 1, wherein the local load-relevant environment data considered are selected from at least one of the following:
wind data about prevailing winds in the construction location,
surface data about a ground surface in the construction location, and
wave behaviour data about expected directions and/or strengths of waves in an offshore application in the construction location,
wherein the predefined rules are such that the first region is chosen in dependence of the local load-relevant environment data.

6. The method according to claim 1, wherein the predefined rules are such that the tower is locally weakened in a first region.

7. The method according to claim 6, wherein the predefined rule are such that the tower comprises a set of a group of construction elements, wherein at least a first group of construction elements is weakened than a second group of construction elements of the set.

8. The method according to claim 7, wherein the first group of construction elements has a different size and/or shape and/or amount of construction elements than the second group of construction elements.

9. The method according to claim 6, wherein the predefined rules are such that the tower is locally weakened by locally decreasing its thickness and/or a thickness of a construction element of it.

10. The method according to claim 6, wherein the predefined rules are such that the tower is locally weakened by locally changing its material quality and/or a material quality of a constructional element of it.

11. The method according to claim 6, wherein the predefined rules are such that the tower is locally weakened by locally changing its directional stiffness.

12. The method according to claim 1, wherein the predefined rules are such that diameters along a circumference of the tower in at least one of its horizontal cross sections differ.

13. A basis of a wind turbine, comprising :
at least a tower, and
a foundation on which the tower rests,
wherein both the tower and the foundation comprises a carrying structure each,
wherein in a first selected region of the basis along a circumference of the tower and/or in a first selected region of the foundation the carrying structure of the basis is weaker in at least one selected horizontal cross-section with respect to possible maximum loads in comparison with a second region of the basis in the selected cross-section.

14. A system for optimising a construction of a basis of a wind turbine, the basis comprising at least a tower and a foundation on which the tower rests, both the tower and the foundation comprising a carrying structure each, the system comprising:
an input interface for data representing a local load environment situation of a construction location where the wind turbine is to be built,
an analysis unit realised to analyse the local load environment situation and to derive from that analysis local load-relevant environment data,
a rule database supplying in operation a set of predefined rules for processing the local load-relevant environment data,
an instruction unit which in operation creates construction instructions for structuring the basis, the construction instructions being based on the local load-relevant environment data and on the set of predefined rules, such that in a first selected region of the basis along a circumference of the tower and/or in a first selected region of the foundation the carrying structure of the basis is weakened in at least one selected horizontal cross-section with respect to possible maximum loads in comparison with a second region of the basis in the selected cross-section,
an output unit for outputting the construction instructions for further processing.
